(19) United States
(12) Patent Application Publication
(10) Pub. No.: US 2008/0011597 A1
(43) Pub. Date: Jan. 17, 2008

(54) Closed system for continuous removal of ethanol and other compounds

(76) Inventor: Wayne W. Spani, Mission Viejo, CA (US)

Correspondence Address: JOHN S. CHRISTOPHER, 6033 WEST CENTURY BOULEVARD, SUITE #400, LOS ANGELES, CA, 90045-6416, US

(21) Appl. No.: 11/827,987

(22) Filed: Jul. 12, 2007

Related U.S. Application Data
(60) Provisional application No. 60/830,574, filed on Jul. 13, 2006.
(60) Provisional application No. 60/831,268, filed on Jul. 17, 2006.

(51) Int. Cl. B01D 3/10

(52) U.S. Cl. 202/84; 202/185.1

(57) ABSTRACT

A closed system for continuous removal of ethanol and other compounds in an aqueous solution includes a centrifuge for removing debris for providing a filtered aqueous solution. A transfer pump and flow control valve control the flow and pressure of the filtered solution. A vacuum pump provides a negative pressure within a boil chamber. An internal heating element within the boil chamber receives the filtered solution preheated by a closed loop heater for maintaining the internal boil chamber temperature. An internal up-spray header sprays droplets of the filtered solution in the boil chamber for controlling the surface area and contact time of the droplets within the boil chamber. The heated vacuum environment within the boil chamber results in the ethanol within the sprayed droplets and a stream of centrifuge off-gas, to be extracted as a vapor and prevent recombination with the filtered solution. A condenser condenses the vapor to liquid ethanol.

This application claims the benefit of U.S. Provisional Patent Application No. 60/830,574 filed on Jul. 13, 2006 entitled Ethanol Removal System and U.S. Provisional Patent Application No. 60/831,268 filed on Jul. 17, 2006 entitled Continuous Compound Removal System, each filed by Wayne W. Spani of Mission Viejo, Calif.

### BACKGROUND OF THE INVENTION

1. Technical Field

The present invention relates to the extraction of compounds from an aqueous solution. More specifically, the present invention relates to methods and apparatus for the (1) extraction of ethanol from an aqueous solution, or (2) the extraction of other materials or compounds from an aqueous solution that have a boiling point below the boiling point of water.

2. Background Art

The prior art is directed to methods and apparatus for extracting ethanol and other materials or compounds from an aqueous solution.

Because petroleum products are projected to be in short supply in the future when compared to petroleum demand, substitutes for petroleum products, particularly gasoline, are being developed today. Ethanol is an alcohol compound that can be created in a chemical process, particularly a fermentation process, and can be utilized as a component to produce a product known as “E-85”. The product “E-85” is a combination of benzine components and ethanol alcohol intended to replace gasoline as a fuel in the operation of automobiles, trucks, water craft engines and the like. Consequently, the production of the product “E-85” for use as a fuel depends upon the availability of the component ethanol.

The fermentation process utilized to create ethanol is well known in the art. A conglomeration of biomass materials known as “mash” in the ethanol refining industry is placed within a fermentation basin tank. The biomass conglomeration can be comprised of corn, sugar beets, rice husks, sugar cane, and any other suitable vegetation material to produce a “mash” in which bacteria, water and heat are introduced to produce the ethanol alcohol. In the prior art process of creating ethanol alcohol, the fermentation tank is employed to collect and hold the conglomerate of biomass materials. Water, bacteria and oxygen are added to the fermentation tank and the contents of the tank are heated to 98 degrees Fahrenheit. This low temperature of 98 degrees Fahrenheit is designed to promote consumption of the biomass material in the fermentation tank by the bacteria which can be, for example, yeast. The yeast bacteria consumes the biomass materials including the sugar cane, rice husks, corn, and sugar beets each of which include high starch and sugar components. This process occurs on the microscopic scale. The end result of this fermentation process comprises a liquid or fluid portion known in the industry as “beer” and a solid portion which is the remains or residue of the biomass materials or “mash” including the rice husks and residual vegetation materials. The liquid or fluid portion known as “beer” is drained off while the solid portion remains in the fermentation tank for the next batch of biomass conglomerate.

Of the liquid portion or “beer” extracted from the fermentation process, only 12%-to-15% is ethanol. This 12%-to-15% of liquid ethanol or “beer” is then directed through a filtering process to remove debris floating in the “beer”. The removed filtered components floating in the “beer” are then removed as a sludge in any number of processes including, for example, an air floatation system, specific gravity separator or skimming. This removed sludge can be directed back to the fermentation tank for use in further ethanol production or, in the alternative, pumped to a sludge tank. The filtered liquid or fluid portion is now referred to as “clear beer”.

The next step in the production of ethanol known in the prior art is typically referred to as the distillation phase where the 12%-to-15% ethanol in a liquid phase is converted to a super saturated gas phase exhibiting a higher percentage of ethanol. Distillation is defined as the process of heating a mixture and condensing the resulting vapor to produce a more nearly pure substance. The “clear beer” is typically directed to a plurality of three distillation columns where the “clear beer” serially passes through the first, then second, and then the third distillation column. The “clear beer” enters the first distillation column and changes state by flashing to steam. As the steam moves up the first distillation column, the steam condenses because of the change in the pressure and temperature within the first distillation column. The liquid phase of the condensate comprising water, alcohol, and beer is deemed waste and drains downward into trays where the waste condensate is drained away and discarded. The “clear beer” is directed through the series of three distillation columns and thus is recycled three times resulting in an output of ethanol in a super saturated gas phase each exiting the top of the first, second and third distillation columns.

The ethanol in the super saturated gas phase from all three distillation columns is then directed to a condenser. The ethanol in the super saturated gas phase is cooled within the condenser and changes state back to a liquid. The liquid output from the condenser is approximately 83% ethanol. The 83% ethanol is then routed to a molecular sieve which functions to extract more water to provide a liquid having an ethanol content within the range of 87%-88%. This high content ethanol is then blended with benzine products to produce the “E-85” fuel which is utilized as a fuel for automobile, truck, water craft and aircraft engines.

One gallon of ethanol contains approximately 84,000 British Thermal Units (BTU's) of energy. Conversely, it takes about 38,000 BTU's of combined energy (including electric, natural gas, coal, bunker fuel of low grade diesel fuel and the like) to produce one gallon of ethanol. Thus, whichever energy source is utilized to produce the ethanol, it takes 38,000 BTU's of energy to produce one gallon of ethanol (which only contains 84,000 BTU's of energy). The most economical of these available fuel sources to produce ethanol is natural gas. Thus, there is a cost associated with each of these available energy sources used to produce ethanol. Thus, a major problem associated with the prior art processes utilized to produce ethanol is that 45%-to-52% of the energy required to manufacture ethanol is consumed in the distillation process of the prior art.

Thus, there is a need in the art for a closed system for the continuous removal of ethanol and other compounds that reduces the energy consumption in the distillation portion of the prior art process of manufacturing ethanol by replacing the distillation columns with a boil chamber having a constant temperature-pressure environment under vacuum designed to remove the ethanol in a gas phase from the “clear beer” and to remove the vaporized ethanol from the boil chamber for condensation and collection.

### DISCLOSURE OF THE INVENTION

Briefly, and in general terms, the present invention provides a new and improved closed system for continuous removal of ethanol and other compounds from an aqueous solution. The present invention is typically utilized (1) for extracting ethanol from an aqueous solution known in the ethanol manufacturing industry as “beer” and (2) for continuously removing waste materials and compounds from an aqueous solution where the waste materials and compounds have a boiling point below the boiling point of water. In the preferred embodiment, the extracted ethanol is employed to produce the fuel “E-85” which can be blended with gasoline to power engines. In the alternative embodiment, the waste materials and compounds which are contaminants contained within the aqueous solution are removed and disposed of while providing purified water as an end product.

In general, gasoline additives and substitutes will soon be in demand to replace the dwindling supply of gasoline and petroleum products. Many fuel efficient engines now being manufactured are designed to operate using clean burning fuels such as “E-85” in combination with gasoline. Ethanol is one of the clean burning fuels being produced and is now being created by using a fermentation process. This fermentation process utilizes a conglomeration of biomass materials known as “mash” placed within a fermentation basin tank. The biomass conglomeration can be comprised of corn, sugar beets, rice husks, sugar cane, and any other suitable vegetation material in which bacteria, water, oxygen and heat are introduced to produce the ethanol alcohol. A low temperature of 98 degrees Fahrenheit is utilized to promote consumption of the high starch and sugar biomass material in the fermentation tank by the bacteria which can be, for example, yeast. This process produces a fluid portion known in the industry as “beer” and a solid portion which is the residue of the biomass “mash”. The liquid “beer” which contains 12%-to-15% ethanol is drained off for processing.

In the present invention, data from selected system components is collected and transmitted to a Programmable Logic System Controller (PLC) utilized for maintaining and controlling a plurality of system operating parameters. The operating parameters include temperature and vacuum pressure within a boil chamber, and the diameter, surface area and contact time, of a plurality of droplets of the aqueous solution introduced into the boil chamber, and fluid and gas flow rates, fluid levels and the like.

In a preferred embodiment, the aqueous solution or “beer” containing the ethanol is pumped from a fermentation tank to a centrifuge where debris or fines contained within the aqueous solution or “beer” is removed. The filtered aqueous solution referred to in the industry as “clear beer” flows to a surge tank which serves to maintain a steady-state flow within the closed system. A computer controlled transfer pump in combination with a flow control valve are used to control both the flow and pressure of the “clear beer” effluent from the surge tank to a boil chamber. The “clear beer” is directed to an internal closed loop heating element within a boil chamber where the “clear beer” is heated to facilitate the separation or extraction of the ethanol as a gas from the “clear beer” within the heated vacuum environment of the boil chamber. The internal closed loop heating element also functions as an internal vapor/gas heater.

A closed loop heater preheats the “clear beer” that is directed to the internal closed loop heating element. The closed loop heater in combination with the internal closed loop heating element cooperate to maintain the internal temperature of the boil chamber which is a critical requirement for preventing the ethanol as a gas from recombining with the liquid “clear beer” while in the boil chamber. A vacuum pump is employed to provide a negative vacuum pressure within the boil chamber so that a heated vacuum environment exists. The heated “clear beer” or filtered aqueous solution is directed to an internal up-spray header where the “clear beer” is discharged in spray droplets where each droplet has a diameter of from 100 microns to 300 microns. The sprayed droplets are intended to expose the largest surface area possible to the heated vacuum environment in the boil chamber. The surface area and contact time of the droplets of “clear beer” sprayed into the heated vacuum environment within the boil chamber is controlled by varying the spray pressure and volume of the internal up-spray header with the computer controlled transfer pump and flow control valve.

A stream of vapor “off-gas” from the centrifuge which also contains ethanol is vacuum drawn through a vapor recovery pipe system to an internal vapor recovery header located within the boil chamber. This process degasses the aqueous solution within the centrifuge and increases the percentage of ethanol extracted from the “clear beer” within the boil chamber. The vapor “off-gas” delivered to the boil chamber from the internal vapor recovery header is distributed evenly to prevent channeling from occurring within the boil chamber and also serves as a carrier aiding in the extraction and flow direction of the ethanol as a gas through and out of the boil chamber. The sprayed droplets of the filtered aqueous solution or “clear beer” and the centrifuge vapor “off-gas” are exposed to the heated vacuum environment of the boil chamber. The negative vacuum pressure and temperature within the boil chamber, and the surface area of the sprayed droplets, and contact time that the sprayed droplets of the filtered aqueous solution are exposed to the heated vacuum environment breaks the azeotrope bond resulting in the ethanol separating or being extracted as a vapor from the filtered aqueous solution. The “clear beer” now stripped of the ethanol gravity drains to a sump within the boil chamber and a sump pump pumps the “clear beer” or resulting filtered aqueous solution out of the boil chamber.

The ethanol as a gas or vapor is drawn upward and out of the boil chamber by the vacuum pump along with the centrifuge vapor “off-gas” through a mist eliminator to minimize any moisture content. The ethanol gas effluent which is maintained at the temperature and pressure of the heated vacuum environment within the boil chamber is passed through the vacuum pump. The vacuum pump seal temperature is controlled by a heat exchanger. The positive pressure output of the vacuum pump (compared to the negative pressure input) draws the ethanol gas effluent to a condenser system where the ethanol gas effluent is cooled and condensed to a liquid. The condensed liquid ethanol then gravity flows to an ethanol holding tank. Any remaining ethanol gas vapor not condensed is further processed or vented to atmosphere.

The present invention is generally directed to a closed system for continuous removal of ethanol and other compounds from an aqueous solution. In its most fundamental embodiment, the closed system includes a centrifuge for receiving an aqueous solution containing ethanol, the centrifuge for separating debris from the aqueous solution for providing a filtered aqueous solution. A transfer pump in combination with a flow control valve is used for controlling the flow and pressure of the filtered aqueous solution from a surge tank to a boil chamber. A vacuum pump provides a negative vacuum pressure within the boil chamber. An internal closed loop heating element located within the boil chamber receives the filtered aqueous solution preheated by a closed loop heater for maintaining the internal environmental temperature within the boil chamber. An internal up-spray header sprays droplets of the filtered aqueous solution into the boil chamber and controls the surface area and contact time of the droplets within the heated vacuum environment. The heated vacuum environment maintained within the boil chamber results in the ethanol contained within the sprayed droplets of the filtered aqueous solution, and a stream of centrifuge off-gas from a vapor recovery header, to separate or be extracted as a vapor and to prevent recombination of the ethanol vapor with the filtered aqueous solution. Finally, a condenser receives and condenses the ethanol vapor to liquid ethanol.

In an alternative embodiment, the closed system is directed to continuously removing waste materials and compounds from an aqueous solution. In the alternative embodiment, the waste materials and compounds have a boiling point below the boiling point of water. A contaminated aqueous solution inlet containing waste materials and compounds in the water is delivered to the closed system. A Diffused Air Flotation System serving as a pre-filtering and pre-separation stage and a Specific Gravity Separator serving as a multi-stage settling tank replace the centrifuge of the preferred embodiment. A surge component tank controls the speed of a centrifugal transfer pump to maintain a continuous water flow rate and pressure throughout the system. A heat exchanger utilizes the cooler pre-filtered contaminated water from the transfer pump to cool the seal of a vacuum pump located at the output of a boil chamber. A micron filter bank filters out particles which are ten microns or greater in diameter that are resident within the contaminated water.

The contaminated water then enters a boil chamber having a structure identical to the structure of the boil chamber of the preferred embodiment. The internal closed loop heating element in combination with the closed loop heater maintains the temperature within the boil chamber at a maximum of 110 degrees Fahrenheit to increase the extraction efficiency of the contaminants. A vacuum pump provides a negative pressure within the boil chamber for maintaining a precise heated vacuum environment therein. The pre-heated contaminated water is then sprayed upwards in atomized droplets by the internal up-spray header for controlling the exposed surface area of the droplets and the contact time that the droplets are in the heated vacuum environment. In the heated, negative one atmosphere vacuum environment, water boils at 112 degrees Fahrenheit while the boiling point of many contaminants is within the range of 98 degrees-to-110 degrees Fahrenheit. Consequently, the contaminants boil off or change phase from a liquid to a vapor prior to the water boiling. The water, stripped of the contaminants, drains to a sump and is pumped out by a sump pump. The vaporized contaminants and volatile organic compounds piped from the Diffused Air Floatation System are drawn through a mist eliminator and vapor recovery piping by the vacuum pump. The contaminated vapors are directed to a condenser where they are cooled and condensed to a liquid state and then drained to a condenser liquid recovery tank for recycling. The cleansed air is then vented to the atmosphere.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1 is a first mechanical schematic diagram of a System for Continuous Removal of Ethanol and Other Compounds of the present invention showing a fines removal centrifuge, surge tank, transfer pump, off-gas vapor recovery pipe, and a programmable Logic System Controller.

FIG. 2 is a second mechanical schematic diagram of the System for Continuous Removal of Ethanol and Other Compounds of the present invention partly in cross-section showing the off-gas vapor recovery pipe, closed loop heater internal pump, boil chamber including a closed loop water heating element, internal up-spray header, and internal vapor recovery header, sump pump and vapor recovery extraction pipe.

FIG. 3 is a third mechanical schematic diagram of the System for Continuous Removal of Ethanol and Other Compounds of the present invention showing the vapor recovery extraction pipe, vacuum pump, heat exchanger, condenser, and ethanol holding tank.

FIG. 4 is an illustration of a molecule of an aqueous solution showing the extraction of ethanol therefrom when exposed to the temperature-pressure environment within the boil chamber of the present invention.

FIG. 5 is a fourth mechanical schematic diagram of a System for Continuous Removal of Ethanol and Other Compounds, a first alternative embodiment of the present invention, showing a diffused air flotation system, vapor recovery pipe, specific gravity separator, surge tank, transfer pump, heat exchanger, and micron filter bank.

FIG. 6 is a fifth mechanical schematic diagram of the System for Continuous Removal of Ethanol and Other Compounds of the first alternative embodiment of the present invention partly in cross-section showing the vapor recovery pipe, closed loop heater, boil chamber including an internal closed loop water heating element, internal up-spray header, internal vapor recovery header, internal submersible discharge pump, and a boil chamber vapor recovery pipe.

FIG. 7 is a sixth mechanical schematic diagram of the System for Continuous Removal of Ethanol and Other Compounds of the first alternative embodiment of the present invention showing the boil chamber vapor recovery pipe, a vacuum pump, condenser, and condensate liquid recovery tank.

### DETAILED DESCRIPTION OF THE INVENTION

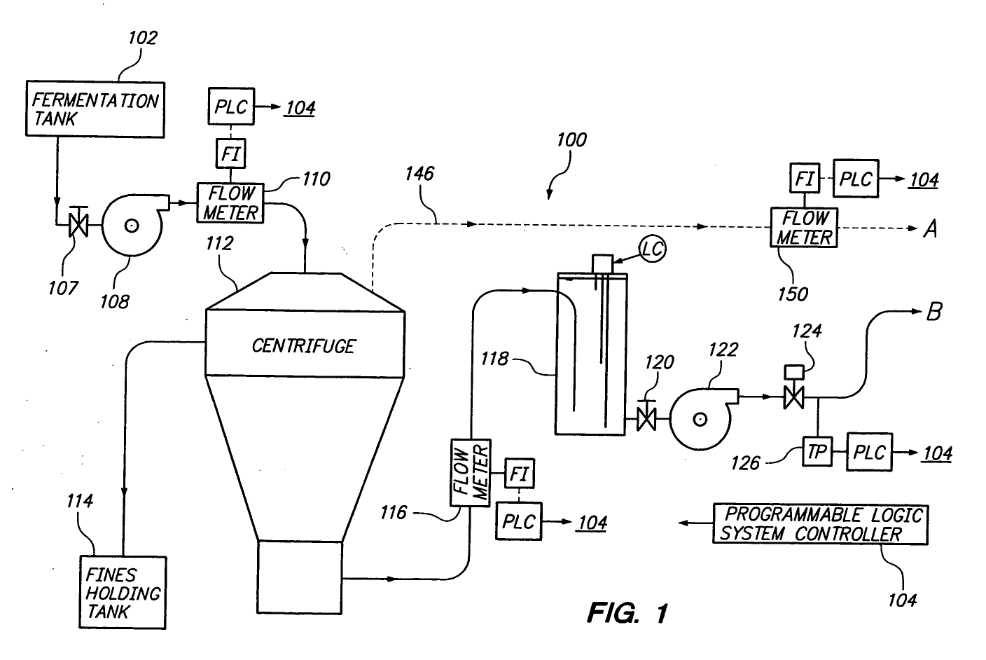

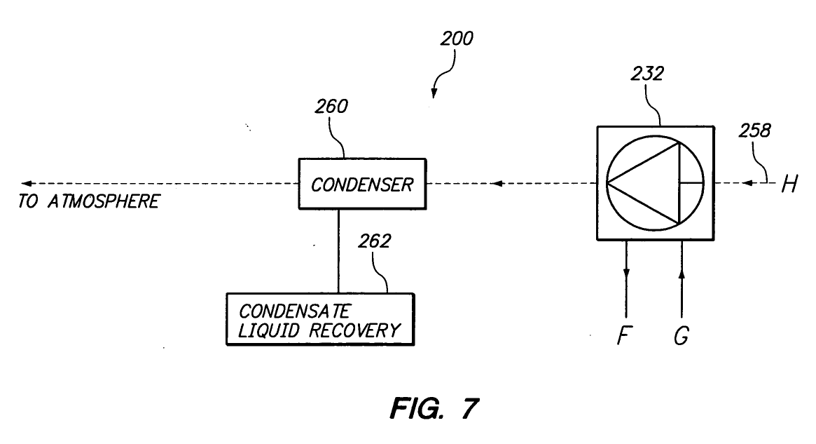

The present invention is a closed system 100 for continuous removal of ethanol and other compounds from an aqueous solution as is illustrated in FIGS. 1-7. The closed system 100 of the present invention is typically utilized (1) for extracting ethanol from an aqueous solution known in the ethanol manufacturing industry as “beer” and, in the alternative, (2) for continuously removing waste materials and compounds which are contaminants from an aqueous solution where the waste materials and compounds have a boiling point below the boiling point of water. In a preferred embodiment identified by the number sequence of the 100 series, the extracted ethanol is utilized to produce the fuel “E-85” which is added to gasoline to serve as a source of fuel for engines. In the alternative embodiment identified by the number sequence of the 200 series, the waste materials and compounds contained within the aqueous solution are removed and disposed of while providing purified water as an end product.

In the preferred embodiment, we are concerned about extracting ethanol in the closed system 100 at the highest extraction efficiency possible from a biomass conglomerate (not shown). Ethanol is one of the clean burning fuels now being produced by using a fermentation process known in the art. This fermentation process utilizes a conglomeration of biomass materials known as “mash” placed within a fermentation basin tank 102. The biomass conglomeration can be comprised of corn, sugar beets, rice husks, sugar cane, and any other suitable vegetation material to produce the “mash” in which bacteria, water and heat are introduced to produce the ethanol alcohol. Water, bacteria and oxygen are added to the fermentation tank 102 and the contents of the tank are heated to 98 degrees Fahrenheit to promote consumption of the biomass material by the bacteria which can be, for example, yeast. The yeast bacteria consumes the biomass materials on a microscopic scale to produce a liquid or fluid portion known in the industry as “beer” and a solid residue portion. The solid portion is either reused in the fermentation process or discarded. The liquid portion or “beer” which contains only 12%-to-15% ethanol, serves as the aqueous solution output from the fermentation tank 102 shown in FIG. 1.

The illustrated preferred embodiment of the closed system 100 is shown in FIGS. 1-4. The closed system 100 for continuous removal of ethanol and other compounds from an aqueous solution is controlled by a Programmable Logic System Controller 104 shown in FIG. 1. In the present invention, data from selected system components is collected and transmitted to the Programmable Logic System Controller 104 which is used for maintaining and controlling a plurality of system operating parameters. On the drawing Figs., transmission of data to the Programmable Logic System Controller 104 is indicated by a box with the letters “PLC” printed therein. The present invention is a closed system and it is critical to maintain stable internal environmental conditions within a boil chamber 106 as necessary to achieve the maximum extraction efficiency of the ethanol from the aqueous solution or “beer”. This is accomplished by the precise monitoring and control of the various parameters. The operating parameters include temperature and vacuum pressure within the boil chamber 106, and the diameter, surface area and contact time of a plurality of droplets of the aqueous solution containing the ethanol to be extracted that are introduced into the boil chamber 106, and the fluid and gas flow rates, fluid levels and the like. Symbols appearing within a box and placed on FIGS. 1-3 that indicate these parameters include “FI” indicating a flow indicator, “TP” indicating a temperature probe, “LI” indicating a fluid level indicator, and “LC” indicating a fluid level controller. Each of these parameter symbols is connected to a box with the printed abbreviation “PLC” for the Programmable Logic System Controller 104 indicating that there is a signal communication between the measured parameter and the Programmable Logic System Controller 104. The Programmable Logic System Controller 104 then monitors and evaluates the measured parameters in order to maintain precise control of the parameters of the closed system 100.

In the preferred embodiment, the aqueous solution or “beer” containing the ethanol to be extracted is pumped via a control valve 107 and a pump 108 from the fermentation tank 102 through a flow meter “FI” 110 and on to a fines removal centrifuge 112 shown in FIG. 1. The flow meter 110 measures the rate of flow of the aqueous solution or “beer” and sends the data to the Programmable Logic Controller (PLC) 104. The raw “beer” enters the centrifuge 112 where debris, small fines and other entrained matter is separated and removed. This step is a refinement process performed on the aqueous solution or “beer” intended to produce a filtered clear liquid. The existence of the filtered clear liquid is required in the process and is intended to prevent any fouling of the interior of the boil chamber 106 which will be discussed in more detail herein below. The sludge or fines removed from the raw “beer” by the centrifuge 112 is directed to a fines holding tank 114 where the sludge or fines can be reintroduced back into the fermentation process or, in the alternative, disposed of. The aqueous solution or “beer” effluent from the centrifuge 112 is now clear or free of sludge or fines and is referred to as a “clear beer”. This situation can be expressed by the simple relationship as follows.
Aqueous Solution (Beer)=Fines+Filtered Aqueous Solution (Clear Beer) (1)
The “clear beer” then exits the bottom outlet of the centrifuge 112 and flows through a flow meter “FI” 116 and the flow rate data is transmitted to the Programmable Logic System Controller 104 shown in FIG. 1.

The “clear beer” is next directed to a surge tank 118 having a level controller associated therewith including operation settings of high, operational, and low. The surge tank 118 functions in a capacitive role maintaining a steady state flow of filtered aqueous solution or “clear beer” in the closed system 100. The filtered aqueous solution in the surge tank 118 passes through another control valve 120 and places a head on a transfer pump 122 shown in FIG. 1. The control of the transfer pump 122 is managed by the Programmable Logic System Controller 104. Further, the level controller “LC” associated with the surge tank 118 also contributes to the operational control of the transfer pump 122. A flow control valve 124 is utilized to control both the flow rate and pressure of the “clear beer” effluent from the transfer pump 122 to the boil chamber 106. The “clear beer” next flows through a temperature meter or probe “TP” 126 and a flow meter “FI” 128 to determine the temperature and flow rate of the filtered aqueous solution or “clear beer” at this location. The data from these two parameter measuring devices is also transmitted to the Programmable Logic System Controller 104 as indicated by the symbol “PLC” appearing in a box.

The “clear beer” is now directed to an internal closed loop heating element 130 within the boil chamber 106 where the “clear beer” is heated to facilitate the separation or extraction of the ethanol as a gas from the “clear beer” within the heated vacuum environment of the boil chamber. As the “clear beer” flows through the heating element 130 within the boil chamber 106, the “clear beer” is heated as required to effect the removal of ethanol within the heated vacuum environment of the boil chamber 106. A closed loop heater 132 positioned external to the boil chamber 106 but in flow communication with input piping to the heating element 130 facilitates the elevation of the temperature of the aqueous solution or “clear beer” within the heating element 130. The closed loop heater 132 is an oil type comprising an internal pump (not shown) and an electric heater (not shown) for heating the media which is oil. The heated oil is pumped through a concentric pipe (not shown) with the filtered aqueous solution or “clear beer” passing through the inner path of the concentric pipe in a counter flow direction. The filtered aqueous solution or “clear beer” absorbs heat from the closed loop heater 132.

The closed loop heater 132 is employed to maintain the temperature of the “clear beer” within the boil chamber 106 to within the range of from 95 degrees Fahrenheit-to-98 degrees Fahrenheit. The temperature range of from 95 degrees Fahrenheit-to-98 degrees Fahrenheit is the same temperature range that the aqueous solution or “beer” is at when exiting the fermentation tank 102. The closed loop heater 132 only functions to maintain the “clear beer” within this temperature range while in the boil chamber 106. Therefore, the closed loop heater 132 functions to preheat the “clear beer” that flows into the heating element 130. The internal closed loop heating element 130 also serves as the internal vapor/gas heater. This action is required to maintain the internal temperature of the boil chamber 106. Consequently, the closed loop heater 132 in combination with the internal closed loop heating element 130 cooperate to maintain the internal temperature of the boil chamber 106. Maintaining the internal temperature of the boil chamber 106 is a critical requirement for preventing the ethanol, once released as a gas vapor from the “clear beer”, from recombining with the “clear beer” in the liquid phase within the boil chamber 106. It is emphasized that the purpose of the closed loop heater 132 is not to boil the filtered aqueous solution or “clear beer” as in the prior art distillation systems.

A vacuum pump 134 is employed in the closed system 100 to provide a negative vacuum pressure within the boil chamber 106. The vacuum pump 134 maintains a vacuum environment within the boil chamber 106 of, for example, up to a minus one atmosphere which is −29.8″ Hg. This level of vacuum drawn in the boil chamber 106 in combination with a temperature maintained within the range of from 95 degrees Fahrenheit-to-98 degrees Fahrenheit creates a heated vacuum environment which promotes the separation or extraction of the ethanol as a vapor from the filtered aqueous solution or “clear beer”. The heating parameters are designed such that the combined effect of the heating element 130 and the closed loop heater 132 on the filtered aqueous solution or “clear beer” never exceeds the maximum temperature of 110 degrees Fahrenheit within the boil chamber 106.

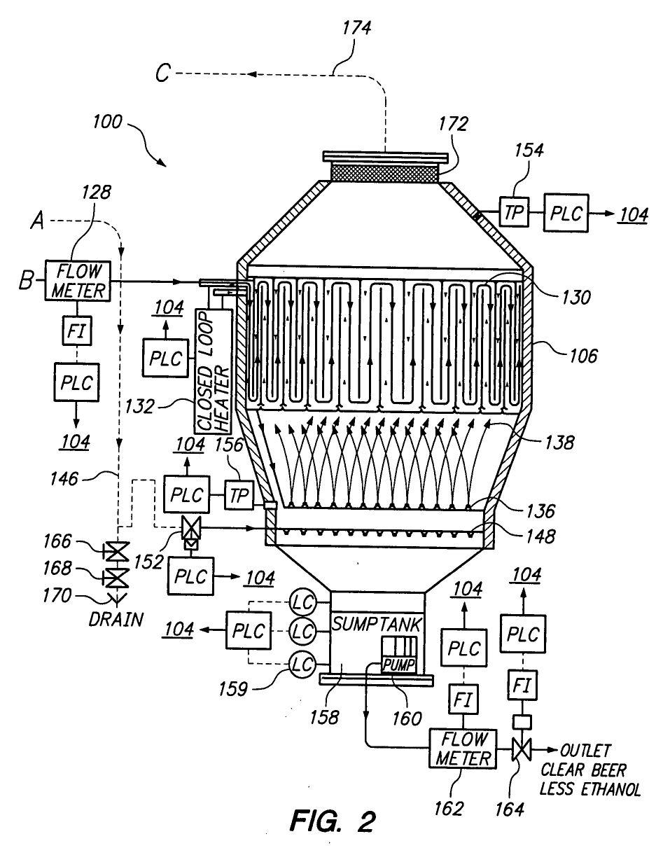

The filtered aqueous solution or “clear beer” is now directed from the heating element 130 to an internal up-spray header 136 located within the boil chamber 106 as shown in FIG. 2. The “clear beer” is discharged from the internal up-spray header in small sprayed droplets 138. This action results in a reduction of the temperature of the sprayed droplets 138 and thus the sprayed droplets 138 are directed upwards into the heated vacuum environment of the boil chamber 106. The diameter of each of the small sprayed droplets 138 of “clear beer” is from 100 microns-to-300 microns where the ideal diameter is 150 microns and the maximum diameter is 300 microns. The sprayed droplets 138 are intended to expose the largest surface area possible to the heated vacuum environment in the boil chamber 106. The surface area of the droplets 138 of “clear beer” and contact time with which the droplets 138 are exposed to the heated vacuum environment within the boil chamber 106 is controlled by the internal up-spray header 136. This control is achieved by varying the spray pressure and volume of the internal up-spray header 136 with the computer controlled transfer pump 122 and flow control valve 124. As a result, the internal up-spray header 136 accomplishes the following. The up-spray header 136 (1) distributes the “clear beer” in the 100 micron-to-300 micron diameter range for injection up into the boil chamber 106, (2) controls the amount of time the droplets 138 are in the boil chamber 106 by utilizing a variable up-spray pressure, and (3) causes the droplets 138 to be exposed to the heated vacuum environment for a certain time period to enable the varying ethanol content to be extracted from the “clear beer”.

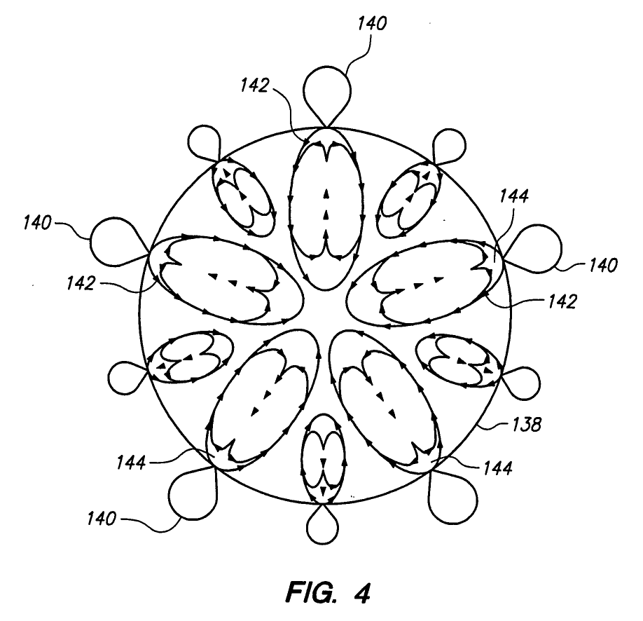

One of the sprayed droplets 138 of the filtered aqueous solution or “clear beer” is shown in FIG. 4. The droplet 138 ideally exhibits a spherical diameter of 150 microns. The droplets 138 are sprayed into and exposed to the heated vacuum environment of the boil chamber 106. The surface area of the droplets 138 and the optimum time that the droplets 138 are exposed to the heated vacuum environment for maximizing the extraction of the ethanol from the droplets 138 of “clear beer” will determine the operational settings of the computer controlled transfer pump 122 and the flow control valve 124. Once exposed to the heated vacuum environment of the boil chamber 106, the ethanol in the form of a vapor 140 releases from the spherical surface of the droplet 138 by breaking the azeotrope bond. The internal currents 142 of the spherical droplet 138 are shown in FIG. 4 as a result of the release of the ethanol vapor 140. Consequently, there is a volume reduction 144 in the sphere of the droplet 138 as a result of the ethanol being released as the vapor 140.

A stream of vapor “off-gas” recovered from the centrifuge 112 is vacuum drawn to the boil chamber 106 via a centrifuge vapor recovery piping system 146 as shown in FIGS. 1 and 2. The centrifuge “off-gas” is delivered to an internal vapor recovery header 148 located within the boil chamber 106. The centrifuge “off-gas” also contains ethanol which can be extracted in the boil chamber 106 just as the ethanol within the “clear beer”. The centrifuge “off-gas” is drawn to the boil chamber 106 via the negative vacuum environment established in the boil chamber 106 by the vacuum pump 134. The “off-gas” is gas generated within the centrifuge 112 during the filtering process of the unfiltered aqueous solution and enters the vapor recovery piping system 146. The off-gas flows through a flow meter “FI” 150 (see FIG. 1) and a flow control valve 152 (see FIG. 2) prior to reaching the internal vapor recovery header 148 located in the boil chamber 106. The flow meter 150 and the flow control valve 152 each transmit measured data to the Programmable Logic System Controller 104.

By vacuum drawing the “off-gas” from the centrifuge 112, the aqueous solution or “beer” will be degassed leading to an increase in the extraction of ethanol from the “clear beer” in the boil chamber 106. The vapor “off-gas” delivered to the boil chamber 106 from the internal vapor recovery header 148 is distributed evenly across the boil chamber 106 to prevent channeling from occurring within the boil chamber 106. Channeling occurs when the off-gas rises up through the boil chamber 106 in a channel-like motion resulting in a lower extraction efficiency of the ethanol. Further, the vapor off-gas also serves as a carrier aiding in the extraction and flow direction of the ethanol as a gas through and out of the boil chamber 106. A pair of temperature probes including a temperature probe “TP” 154 and a temperature probe “TP” 156 deliver temperature data to the Programmable Logic System Controller 104 for monitoring and maintaining the internal environmental conditions of the boil chamber 106.

The small sprayed droplets 138 of the filtered aqueous solution or “clear beer” and the centrifuge vapor “off-gas” are exposed to the heated vacuum environment within the boil chamber 106. The negative vacuum pressure and the temperature maintained within the boil chamber 106, and the surface area of the sprayed droplets 138, and the contact time that the sprayed droplets 138 of the filtered aqueous solution are exposed to the heated vacuum environment breaks the azeotrope bond resulting in the ethanol separating and being extracted as a vapor from the filtered aqueous solution and the centrifuge “off-gas”. The azeotrope bond is defined as the molecular bond that holds the ethanol to the filtered aqueous solution or “clear beer”. See FIG. 4 for an illustration of this process. The reason that droplet spheres of “clear beer” should be small, where a diameter of 150 microns is optimum, is that when smaller droplet spheres of “clear beer” are exposed to the heated vacuum environment within the boil chamber 106, the ethanol extraction efficiency is highest. Thus, the highest percentage of ethanol can be extracted from smaller droplet spheres. This is because the azeotrope bond for droplet spheres having a diameter less than 300 microns is lower. Droplet spheres of “clear beer” having a diameter larger than 300 microns have been shown to be more resistant to extraction of the ethanol from the “clear beer”. This is because the azeotrope bond is greater for droplet spheres of “clear beer” having a diameter greater than 300 microns.

The “clear beer now stripped of the ethanol contained therein gravity drains to a sump 158 within the boil chamber 106. The sump 158 includes a three level sump level control sensor “LC” 159 to sense the fluid level in the sump 158. Each of the three levels of the control sensor “LC” 159 transmits a data signal to the Programmable Logic System Controller 104 to indicate whether the fluid level in the sump 158 is high, medium or low. A sump pump 160 located within the sump 158 pumps the residue filtered aqueous solution or “clear beer” out of the boil chamber 106. The three level control sensor “LC” 159 automatically initiates pumping action by the sump pump 160. For example, a high level of “clear beer” effluent would trigger the high level indicator of the level sensor 159 and automatically start the sump pump 160. The residue “clear beer” effluent pumped from the sump 158 flows through a water flow indicator-meter 162 and a water outlet flow control valve 164, each of which sends measured data to the Programmable Logic System Controller 104. The discharged residue “clear beer” can be recycled for use in the fermentation tank 102 or further processed for discharge. At the end of the centrifuge vapor recovery piping system 146 is a pair of drain valves 166 and 168 leading to a drain 170 as shown in FIG. 2

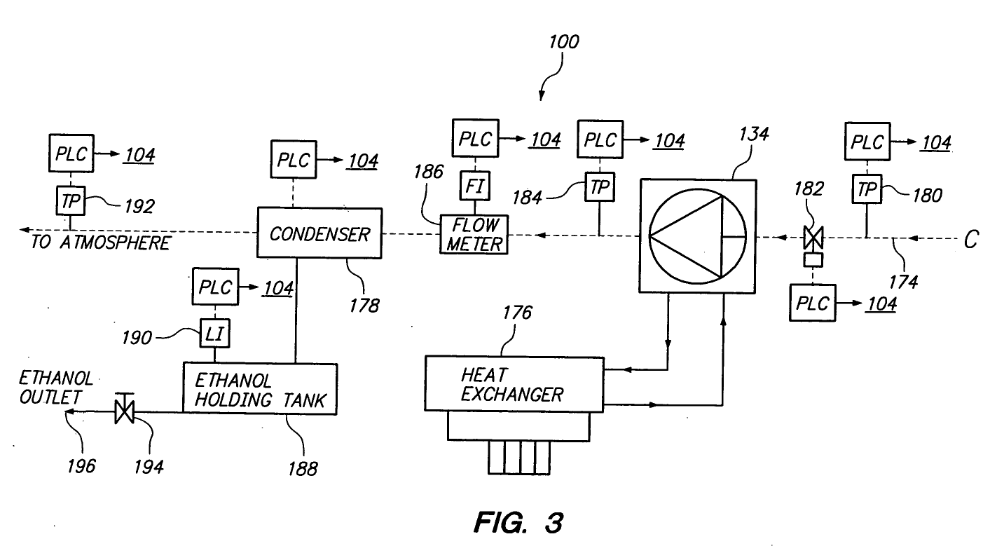

The ethanol in the form of a gas or vapor is drawn upward and out of the boil chamber 106 by the vacuum pump 134 along with the centrifuge “off-gas”. The combined ethanol vapor passes through a coalescing mist eliminator media 172 to minimize any moisture content as shown in FIG. 2. The boil chamber 106 and all piping systems including a vapor recovery extraction pipe 174 rising out of the boil chamber 106 are insulated to retain and control the temperature and pressure of the heated vacuum environment within the boil chamber 106. The vacuum pump 134 which is sized to maintain a full negative atmosphere in the boil chamber 106 during operations draws the ethanol effluent into the vapor recovery extraction pipe 174 and through the vacuum pump 134 as shown in FIG. 3. The temperature of the water used to cool the liquid ring vacuum pump 134 is controlled by a forced draft heat exchanger system 176. In the vacuum pump 134, the suction inlet is a negative pressure when compared to the discharge end within the range of 1-to-3 pounds per square inch (psi). In a positive pressure environment, the ethanol vapor can be condensed back to the liquid phase. The condensation of the ethanol vapor to a liquid phase is accomplished in a condenser 178 which can be, for example, an impaction chilled tube type condenser comprised of an internal tubular structure inside a sealed housing. Inside the internal tubular structure, a chilled glycol solution is circulated to meet the ethanol due point allowing the ethanol vapor to condense into a liquid phase.

Several parameters are measured after the ethanol vapor leaves the boil chamber 106. In the vapor recovery extraction pipe 174, an “off-gas” temperature probe 180 measures the temperature of the “off-gas”, and a boil chamber vacuum pressure control valve 182 controls the vacuum pressure in the extraction pipe 174. Prior to the ethanol vapor entering the condenser 178, the ethanol vapor flows through a temperature probe “TP” 184 and then through a flow indicator “FI” 186. The condensed ethanol then gravity flows out of the condenser 178 into an ethanol holding tank 188 which includes a level indicator “LI” 190 which indicates the level of liquid ethanol present within the holding tank 188. Any remaining vapor not condensed to the liquid phase flows through a temperature indicator “TP” 192 for indicating the temperature thereof. The remaining vapor is now dried and free of ethanol and can be further processed or vented to atmosphere. An ethanol outlet valve 194 controls the flow of the liquid ethanol from the ethanol holding tank 188 to a liquid ethanol outlet 196 shown in FIG. 3. Each of these measuring devices transmits data to the Programmable Logic System Controller 104 shown on FIG. 1.

In summary, the most fundamental embodiment of the closed system 100 for continuous removal of ethanol and other compounds includes a centrifuge 112 for receiving an aqueous solution containing ethanol, the centrifuge 112 for separating debris from the aqueous solution for providing a filtered aqueous solution. A transfer pump 122 in combination with a flow control valve 124 is used for controlling the flow and pressure of the filtered aqueous solution from a surge tank 118 to a boil chamber 106. A vacuum pump 134 provides a negative vacuum pressure within the boil chamber 106. An internal closed loop heating element 130 located within the boil chamber 106 receives the filtered aqueous solution preheated by a closed loop heater 132 for maintaining the internal environmental temperature within the boil chamber 106. An internal up-spray header 136 sprays droplets of the filtered aqueous solution into the boil chamber 106 and controls the surface area and contact time of the droplets within the heated vacuum environment. The heated vacuum environment maintained within the boil chamber 106 results in the ethanol contained within the sprayed droplets of the filtered aqueous solution, and a stream of centrifuge off-gas from a vapor recovery header 148, to separate or be extracted as a vapor and prevent recombination of the ethanol vapor with the filtered aqueous solution. Finally, a condenser 178 receives and condenses the ethanol vapor to an liquid ethanol.

The present invention provides novel advantages and structural features over other systems designed to remove ethanol from an aqueous solution. First, the closed loop heater 132 and the internal closed loop heating element 130 combine to enable the “clear beer” to be heated to a maximum temperature of 110 degrees Fahrenheit in the boil chamber 106. This combination of structure provides a necessary component of the heated vacuum environment required to cause the ethanol to be extracted from the “clear beer”. Second, the internal closed loop heating element 130, the conical expansion of the boil chamber 106, and the continuous automatic operating/processing feature of the internal submersible discharge sump pump 160 combine to maintain a constant internal temperature of the “clear beer” and the ethanol vapor/gas pressure (i.e., heated vacuum environment) for maximizing the extraction efficiency. Third, the unique structural design of the boil chamber 106 having a conical expansion, enables the ethanol vapor/gas to naturally expand within the top of the boil chamber 106 to maximize the extraction of ethanol as a vapor/gas from the “clear beer” so as not to cause a pressure change. The boil chamber 106 exhibits a reduced diameter/volume at the base thereof with increasing internal volume as a function of the height of the conical boil chamber 106. Fourth, the internal submersible discharge sump pump 160 provides a continuous automatic operation so that the vapor/gas pressure within the boil chamber 106 remains constant. Consequently, there are no disruptions or wild variations in the internal gas pressure within the boil chamber 106 that would result in a reduction of the extraction efficiency of the ethanol removing cycle. Fifth, the internal up-spray header 136, the transfer pump 122, and the flow control valve 124 in combination control the contact time between the spray droplets of “clear beer” and the heated vacuum environment of the boil chamber 106, where the ethanol extraction efficiency being, in part, a function of the contact time. Sixth and finally, the closed system 100 for the continuous removal of ethanol and other compounds reduces the energy consumption required in the prior art distillation process of manufacturing ethanol by replacing the distillation columns with a boil chamber 106 having a constant heated vacuum environment designed to remove the ethanol in a gas phase from the “clear beer” and to remove the vaporized ethanol from the boil chamber for condensation and collection. The ethanol extraction efficiency is within the range of 98%-to-99%.

An alternative embodiment of the closed system for continuous removal of ethanol and other compounds from an aqueous solution will now be disclosed. Components of the alternative embodiment having like structure and function to those corresponding components of the preferred embodiment 100 will be identified by corresponding numbers of the 200 series.

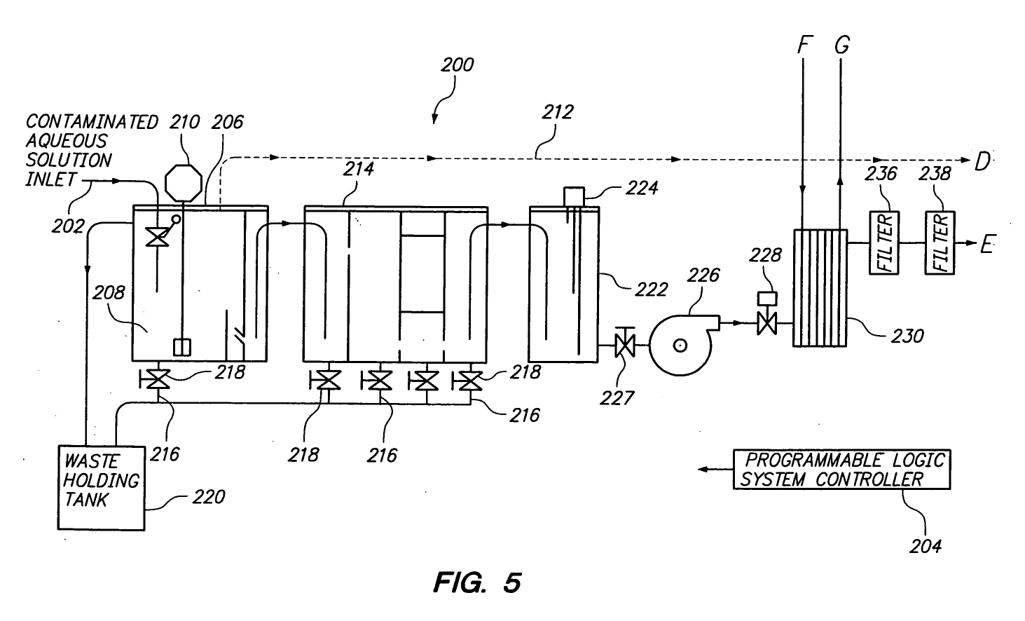

The closed system 200 of the alternative embodiment is very similar to the closed system 100 of the preferred embodiment except for changes in the filtering stage of the aqueous solution and the end product. The closed system 200 functions to continuously remove waste materials and compounds which are contaminants from an aqueous solution where the waste materials and compounds typically have a boiling point below the boiling point of water. In the closed system 200 of the alternative embodiment, the waste materials and compounds contained within the aqueous solution such as, for example, petroleum and hydrocarbons, are removed and disposed of while providing purified water as an end product. A contaminated aqueous solution inlet 202 containing waste materials and compounds is delivered to the closed system 200 as shown in FIG. 5. As with the preferred embodiment 100, the closed system 200 is controlled by a Programmable Logic System Controller 204 shown in FIG. 5. In the present invention, data from selected system components is collected and transmitted to the Programmable Logic System Controller 204 which is used for maintaining and controlling a plurality of system operating parameters.

In the present invention, the contaminated aqueous solution (hereinafter “contaminated solution”) enters a diffused air flotation system 206 which functions as a pre-filtering and pre-separation stage. This pre-filtering and pre-separation stage of the diffused air flotation system 206 includes a tank 208 which includes components for generating air bubbles via an agitator 210 within the contaminated solution for attaching to solid pollutants. The air bubbles cause the solid pollutants to float within the tank 208 so that they can then be removed by a skimming operation. The tank 208 of the diffused air flotation system 206 also serves as a preliminary air flow stripper. Additionally, volatile organic compounds are also separated from the contaminated solution by an air stripping operation and are then removed from the tank 208 through a vent pipe or diffused air flotation vapor recovery pipe 212 as shown in FIG. 5. A specific gravity separator 214, which is a multi-stage settling tank, receives the contaminated solution from the diffused air flotation system 206. The specific gravity separator 214 includes a plurality of drain ports 216 having a corresponding plurality of manual operating valves 218 used to drain off sludge and sediment. The drained sludge and sediment from the specific gravity separator 214 are directed to a waste holding tank 220 which is periodically emptied.

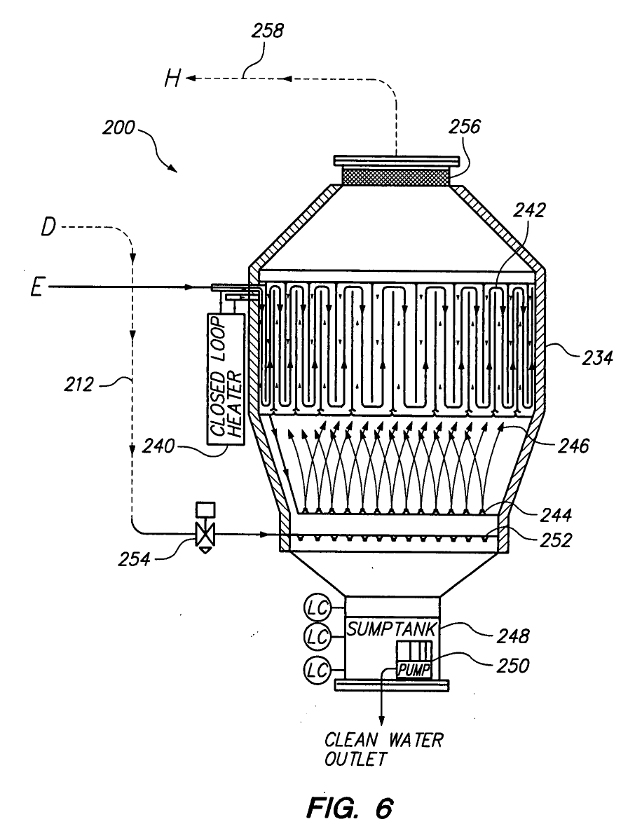

A surge tank 222 receives the filtered contaminated solution from the specific gravity separator 214 as shown in FIG. 5. The surge tank 222 employs a three-level water controller 224 for controlling the speed of a discharge centrifugal transfer pump 226. A valve 227 is located between the surge tank 222 and the discharge centrifugal transfer pump 226 for isolating the transfer pump 226 when necessary. The discharge centrifugal transfer pump 226 in combination with a flow regulating valve 228 function to maintain a continuous water flow rate and water pressure throughout the closed system 200. A plate and frame heat exchanger 230 utilizes the cool pre-filtered, contaminated solution discharged from the centrifugal transfer pump 226 to cool the seal in a concentric water jacket of a liquid ring vacuum pump 232. The vacuum pump 232 is located on the output side of a boil chamber 234 as shown in FIG. 6. A micron filter bank comprising a pair of filter elements 236, 238 is employed to filter out stray particles resident within the contaminated solution that are greater than or equal to 10 microns in diameter.

The contaminated solution of the closed system 200 is then directed to the boil chamber 234. The boil chamber 234 of the closed system 200 exhibits a structure identical to the structure of the boil chamber 106 of the closed system 100 of the preferred embodiment. The contaminated solution enters a closed loop heater 240 positioned external to the boil chamber 234 but in flow communication with the input piping to an internal closed loop heating element 242. The closed loop heater 240 facilitates the elevation of the temperature of the filtered contaminated solution within the heating element 242. The closed loop heater 240 is an oil type heater comprising an internal pump (not shown) and an electric heater (not shown) for heating the media which is oil. The heated oil is pumped through a concentric pipe (not shown) with the filtered contaminated solution passing through the inner path of the concentric pipe in a counter flow direction. The filtered contaminated solution absorbs heat from the closed loop heater 240. After leaving the closed loop heater 240, the filtered contaminated solution is directed through the internal closed loop heating element 242.

The closed loop heater 240 is employed to maintain the temperature of the contaminated solution within the boil chamber 234 at 110 degrees Fahrenheit. The closed loop heater 240 only functions to maintain the contaminated aqueous solution at this 110 degree Fahrenheit temperature while in the heating element 242 of the boil chamber 234. Therefore, the closed loop heater 240 functions to preheat the contaminated solution that flows into the heating element 242. The internal closed loop heating element 242 is positioned around the internal diameter of the boil chamber 234 where the contaminated aqueous solution is permitted to reach a maximum temperature of 110 degrees Fahrenheit. Maintaining the temperature of the contaminated solution within the heating element 242 at 110 degrees Fahrenheit by employing the closed loop heater 240 increases the efficiency of the extraction of the contaminants such as petroleum and hydrocarbons within the boil chamber 234. It is emphasized that the purpose of the closed loop heater 240 is not to boil the filtered contaminated solution as in prior art distillation systems. Additionally, the vacuum pump 232 provides a negative vacuum pressure within the boil chamber 234 for maintaining a precise heated vacuum environment therein. This design assures that there will be no variations in vacuum pressure and temperature in the boil chamber 234 which could negatively affect the extraction efficiency of the contaminants.

The pre-heated contaminated solution is then directed from the internal closed loop heating element 242 to an internal up-spray header 244 as is shown in FIG. 6. The contaminated solution is forced sprayed upwards in a plurality of atomized droplets 246. The upward spraying procedure causes the temperature of the sprayed droplets 246 to lower. However, the sprayed droplets rise upwards into and gravity fall through the heated vacuum environment of the boil chamber 234 returning the temperature of the contaminated solution to the operating temperature of 110 degrees Fahrenheit. This up-spray process ensures the control of the contact time in which the sprayed atomized droplets 246 of contaminated solution are exposed to the heated vacuum environment maintained within the boil chamber 234. The contact time is controlled by the pressure settings of the centrifugal transfer pump 226 and the flow regulating valve 228 shown in FIG. 5. Likewise, the surface area of the sprayed atomized droplets of contaminated solution are controlled to maximize the extraction efficiency of the contaminants. As described in the closed system 100 of the preferred embodiment, the diameter of a sprayed droplet 246 of contaminated solution should be within the range of 100 microns-to-300 microns. An optimum diameter of a droplet 246 of contaminated solution is 150 microns since the extraction efficiency of contaminants is highest for a droplet 246 of this size. This is the case since the azeotrope bond holding the contaminant to the contaminated solution is lower for a droplet 246 having a 150 micron diameter and thus easier to extract. In the alternative, the azeotrope bond holding the contaminant to the contaminated solution is higher for a droplet 246 having a diameter equal to or greater than 300 microns and thus more difficult to extract. A detailed description of the properties of extracting a component from a molecule of filtered aqueous solution is disclosed in reference to the closed system 100 of the preferred embodiment and in FIG. 4.

The vacuum pump 232 maintains a vacuum environment within the boil chamber 234 of up to a minus one atmosphere (−29.8″ Hg). At sea level where the atmospheric pressure is plus one atmosphere (+29.8″ Hg), water boils at 212 degrees Fahrenheit. In the heated, negative one atmosphere vacuum environment of the boil chamber 234, water boils at 112 degrees Fahrenheit. Furthermore, in the heated vacuum environment of the boil chamber 234, the boiling point of many pollutant contaminants is within the range of 98 degrees Fahrenheit-to-110 degrees Fahrenheit. When the pre-heated atomized droplets 246 are up-sprayed into the heated vacuum environment of the boil chamber 234, the contaminants boil off of the surface of the atomized droplets 246 of the contaminated solution in the 110 degree heated vacuum environment. Thus, the contaminants boil off into a vapor prior to the remainder of the aqueous solution, typically comprising water, which does not flash to a vapor until the temperature reaches 112 degrees Fahrenheit in the negative one atmosphere environment of the boil chamber 234. However, the temperature within the boil chamber 234 is maintained at 110 degrees Fahrenheit and never reaches a level of 112 degrees Fahrenheit. The atomized droplets 246 of contaminated solution now stripped of the contaminants are now comprised of pure water droplets. The pure water droplets then gravity fall downward into a sump tank 248 where an internal submersible discharge pump 250 pumps the purified water out of the boil chamber 234 in a continuous operation.

As previously noted, volatile organic compounds are separated as a vapor from the contaminated solution by an air stripping operation and then removed from the tank 208 through a vent pipe or diffused air flotation vapor recovery pipe 212 as shown in FIG. 5. The diffused air flotation vapor recovery pipe 212 extends from the tank 208 of the diffused air flotation system 206 to an internal vapor recovery header 252 located in the boil chamber 234 as shown in FIG. 6. A control (shut off) valve 254 is positioned in the diffused air flotation vapor recovery pipe 212 between the tank 208 of the diffused air flotation system 206 and the internal vapor recovery header 252 for blocking the volatile organic compounds when necessary. Thus, the volatile organic compounds are introduced into the boil chamber 234 via the internal vapor-recovery header 252.

The contaminated vapor that was extracted (boiled off) from the surface of the contaminated droplets 246 of the contaminated solution in the boil chamber 234 and the volatile organic compounds (vapor) from the internal vapor recovery header 252 are drawn through the heated vacuum environment by the negative vacuum pressure in the boil chamber 234. The combined contaminated vapor and volatile organic compounds (vapor) rise upwards drawn by the vacuum pump 232 and pass through a mist eliminator impaction media 256 and into a boil chamber vapor recovery piping system 258. The pressure of the combined contaminated vapor and volatile organic compounds (vapor) increases at the discharge side of the vacuum pump 232 to a range of from 1.0 psi-to-3.5 psi. The vapor expands and cools wherein the cooled contaminated vapor is delivered to a condenser 260 of the impaction plate type. The condenser 260 further cools and condenses the combined contaminated vapor and volatile organic compounds (vapor), causing a change of state to a liquid. The condensed contaminated liquid is then drained to a condenser liquid recovery tank 262 for recycling or further processing. The cleansed air then exits the condenser 260 and is vented to atmosphere.

The specific characteristics of the closed system 200 of the present invention that distinguish it over the prior art systems for removing contaminants from an aqueous solution include (1) heating the contaminated aqueous solution to a maximum of 110 degrees Fahrenheit, (2) maintaining a constant internal temperature of the contaminated solution and a constant vapor pressure within the boil chamber 234, (3) compensating for the expansion of the contaminated vapor and maintaining a constant vapor pressure through the design of the boil chamber 234 for the efficient removal of contaminants, (4) providing a continuous process wherein the vapor pressure is maintained constant for maximizing contaminant extraction efficiency, (5) use of the internal submersible discharge pump 250 to pump out processed (purified) water at a continuous rate, and (6) use of a Programmable Logic System Controller (PLC) 204 for monitoring the output signals of selected components for maintaining the environmental conditions of the boil chamber 234.

In summary, the most fundamental embodiment of the closed system 200 for the continuous removal of contaminants from an aqueous solution includes a diffused air floatation system 206 in combination with a specific gravity separator 214 for receiving an aqueous solution containing contaminants. The air floatation system 206 and the specific gravity separator 214 function to remove debris and to provide a filtered aqueous solution. A transfer pump 226 in combination with a flow control valve 228 controls the flow and pressure of the filtered aqueous solution from a surge tank 222 to a boil chamber 234. A vacuum pump 232 provides a negative pressure within the boil chamber 234. An internal closed loop heating element 242 located within the boil chamber 234 receives the filtered aqueous solution preheated by a closed loop heater 240 for maintaining the internal environmental temperature within the boil chamber 234. An internal up-spray header 244 sprays droplets 246 of the filtered aqueous solution into the boil chamber 234 for controlling the surface area and contact time of the droplets 246 within the heated vacuum environment. The heated vacuum environment maintained within the boil chamber 234 results in the contaminants contained within the sprayed droplets 246 of the filtered aqueous solution, and a stream of volatile organic compounds from a vapor recovery header 252 being extracted as a vapor. Furthermore, the heated vacuum environment prevents recombination of the extracted contaminant vapor with the filtered aqueous solution. Finally, a condenser 260 receives and condenses the contaminant vapor to a contaminant liquid.

The present invention provides novel advantages and structural features over other systems designed for the continuous removal of contaminants from a contaminated aqueous solution. First, the closed loop heater 240 and the internal closed loop heating element 242 combine to enable the contaminated aqueous solution to be heated to a maximum temperature of 110 degrees Fahrenheit in the boil chamber 234. This combination of structure provides a necessary component of the heated vacuum environment required to cause the contaminants to be extracted from the contaminated aqueous solution. Second, the internal closed loop heating element 242, the conical expansion of the boil chamber 234, and the continuous automatic operating/processing feature of the internal submersible discharge sump pump 250 combine to maintain a constant internal temperature of the contaminated aqueous solution and the contaminated vapor pressure (i.e., heated vacuum environment) for maximizing the extraction efficiency. Third, the unique structural design of the boil chamber 234 having a conical expansion, enables the contaminated vapor to naturally expand within the top of the boil chamber 234 to maximize the extraction of the contaminated vapor from the aqueous solution so as not to cause a pressure change. The boil chamber 234 exhibits a reduced diameter/volume at the base thereof with increasing internal volume as a function of the height of the conical boil chamber 234. Fourth, the internal submersible discharge pump 250 provides a continuous automatic operation so that the contaminated vapor pressure within the boil chamber 234 remains constant. Consequently, there are no disruptions or wild variations in the internal gas pressure within the boil chamber 234 that would result in a reduction of the extraction efficiency of the ethanol removing cycle. Fifth, the internal up-spray header 244, the transfer pump 226, and the flow regulating valve 228 in combination control the contact time between the spray droplets 246 of the contaminated solution and the heated vacuum environment of the boil chamber 234, where the contaminant extraction efficiency being, in part, a function of the contact time. Sixth and finally, the closed system 200 for the continuous removal of contaminants reduces the energy consumption required in the prior art distillation process of removing contaminants.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility.

It is therefore intended by the appended claims to cover any and all such modifications, applications and embodiments within the scope of the present invention. Accordingly,

What is claimed is:

1. A closed system for continuous removal of a specific component from an aqueous solution comprising:
means for filtering debris from a received aqueous solution containing a specific component for providing a filtered aqueous solution;
means for providing a negative vacuum pressure within a boil chamber;
means for receiving said filtered aqueous solution for maintaining the internal environmental temperature and providing a heated vacuum environment within said boil chamber;
means for spraying droplets of said filtered aqueous solution into said boil chamber for controlling the surface area and contact time of said droplets within said heated vacuum environment;
said heated vacuum environment maintained within said boil chamber resulting in said specific component contained within said sprayed droplets of said filtered aqueous solution being extracted as a vapor and preventing recombination of said extracted component vapor with said filtered aqueous solution; and
means for receiving and condensing said component vapor to a component liquid.

2. The closed system of claim 1 further including means for controlling the flow and pressure of said filtered aqueous solution from a surge tank to said boil chamber.

3. The closed system of claim 1 wherein a surge tank maintains a steady-state flow of said filtered aqueous solution in said closed system.

4. The closed system of claim 1 wherein a programmable logic system controller is employed to monitor and control a plurality of parameters of said closed system.

5. The closed system of claim 1 wherein said means for maintaining the internal environmental temperature within said boil chamber comprises an internal closed loop heating element in combination with a pre-heating closed loop heater.

6. The closed system of claim 1 wherein a combination of an internal closed loop heating element, a conical expansion of said boil chamber, and the continuous operation of an internal submersible discharge pump comprises said means for maintaining the internal environmental temperature of said filtered aqueous solution and a constant vapor pressure for maximizing extraction efficiency.

7. The closed system of claim 1 wherein a combination of an internal up-spray header, a transfer pump, and a flow control valve regulate the contact time between said sprayed droplets of said filtered aqueous solution and said heated vacuum environment of said boil chamber for increasing the component vapor extraction efficiency.

8. The closed system of claim 1 further including a holding tank in contact with said filtering means for storing said debris separated from said aqueous solution.

9. The closed system of claim 1 wherein said means for maintaining the internal environmental temperature includes a closed loop heater for preheating said filtered aqueous solution to a temperature range of from 95 degrees Fahrenheit-to-98 degrees Fahrenheit.

10. The closed system of claim 1 wherein said droplets of filtered aqueous solution sprayed into said boil chamber have a diameter of less than or equal to 300 microns.

11. The closed system of claim 1 further including a mist eliminator impact media located within said boil chamber for removing moisture from said extracted component vapor.

12. The closed system of claim 1 further including an internal submersible discharge pump located within said boil chamber for pumping said aqueous solution less said extracted component out of said boil chamber.

13. The closed system of claim 1 further including a heat exchanger for controlling the temperature of a vacuum pump.

14. The closed system of claim 1 wherein said boil chamber exhibits a conical expansion for enabling said extracted component vapor to expand for maximizing the extraction efficiency without a pressure change within said boil chamber.

15. A closed system for removal of ethanol from an aqueous solution comprising:
means for filtering debris from a received aqueous solution containing ethanol for providing a filtered aqueous solution;
means for controlling the flow and pressure of said filtered aqueous solution from a surge tank to a boil chamber;
a vacuum pump for providing a negative pressure within said boil chamber;
an internal closed loop heating element for receiving said filtered aqueous solution preheated by a closed loop heater for maintaining the internal environmental temperature and providing a heated vacuum environment within said boil chamber;
an internal up-spray header for spraying droplets of said filtered aqueous solution into said boil chamber for controlling the surface area and contact time of said droplets within said heated vacuum environment;
said heated vacuum environment maintained within said boil chamber resulting in said ethanol contained within said sprayed droplets of said filtered aqueous solution being extracted as a vapor and preventing recombination of said extracted ethanol vapor with said filtered aqueous solution; and
a condenser for receiving and condensing said ethanol vapor to liquid ethanol.

16. The closed system of claim 15 wherein said negative pressure and said internal temperature within said boil chamber, and the surface area and contact time of said sprayed droplets of said filtered aqueous solution within said heated vacuum environment of said boil chamber breaks an azeotrope bond resulting in said ethanol being extracted as a vapor from said filtered aqueous solution.

17. The closed system of claim 15 further including an ethanol holding tank for receiving and storing said liquid ethanol from said condenser.

18. A closed system for continuous removal of contaminants from an aqueous solution comprising:
means for filtering debris from a received aqueous solution containing a plurality of contaminants for providing a filtered aqueous solution;
means for controlling the flow and pressure of said filtered aqueous solution from a surge tank to a boil chamber;
a vacuum pump for providing a negative pressure within said boil chamber;
an internal closed loop heating element for receiving said filtered aqueous solution preheated by a closed loop heater for maintaining the internal environmental temperature and providing a heated vacuum environment within said boil chamber;
an internal up-spray header for spraying droplets of said filtered aqueous solution into said boil chamber for controlling the surface area and contact time of said droplets within said heated vacuum environment;
said heated vacuum environment maintained within said boil chamber resulting in said contaminants contained within said sprayed droplets of said filtered aqueous solution being extracted as a vapor and preventing recombination of said extracted contaminant vapor with said filtered aqueous solution; and
a condenser for receiving and condensing said contaminant vapor to a contaminant liquid.

19. The closed system of claim 18 further including a micron filter bank for filtering out particles of greater than or equal to ten microns from the filtered aqueous solution.

20. The closed system of claim 18 further including a condenser liquid recovery holding tank for receiving and storing said contaminated liquid from said condenser.
